(19) United States
(12) Patent Application Publication
(10) Pub. No.: US 2001/0030107 A1
(43) Pub. Date: Oct. 18, 2001

(54) Auger lock

(76) Inventor: Peter Simpson, Hamilton (CA)

Correspondence Address: Mark A. Koch, 866 Main Street East, Hamilton, ON, L8M 1L9, CA

(21) Appl. No.: 09/749,767

(22) Filed: Dec. 28, 2000

Related U.S. Application Data
(60) Provisional application No. 60/174,170, filed on Jan. 3, 2000.

(51) Int. Cl. B65G 33/22

(52) U.S. Cl. 198/670

(57) ABSTRACT

An auger lock for conveying particulate material there through, said auger lock includes an auger tube receiving particulate material therein including an auger section, a material plug section, and an exit section. In the auger section; a drive for rotating a rotatable spiral auger mounted concentrically on a rotatable drive shaft within said auger tube for conveying particulate material there through. In the material plug section; conveyed particulate material is allowed to accumulate and compact to form a material plug to minimize free flow of gases through said auger tube. In said exit section; a means for discharging said particulate material from said auger tube. Further including a spring for biasing said exit door into a closed position, wherein said exit door moveable between a exit door open position and a exit door closed position, wherein said closed position said exit door seals off an exit end of said auger tube preventing flow of material and gas through said exit end, and in said open position allowing flow of material through said exit end.

### FIELD OF THE INVENTION

The present invention relates to transporting a particulate material through an auger which pressure isolates the inlet of the auger from the outlet of the auger.

### BACKGROUND OF THE INVENTION

Many processes involve transporting particulate material by entraining the particulate material in an air stream and/or gases stream to move the particulate material to a collection area. Some kind of conveying devices operate to move the particulate material from the collection area to another desired location such as a discharge bin, transport vehicle, conveyor or the like. A typical installation may move particulate material from a bin or storage area into a transport vehicle such as a truck. During the movement of the particulate material from the storage bin to its final destination, the particulate material is often entrained in an air stream and is discharged into a cyclone or the like for separating the air from the particulate material in the cyclone. The particulate material while being entrained in air will often be moved either under positive pressure or under a vacuum. The air or gas is normally removed in the cyclone and separated from the particulate material. The particulate material is then moved via a conveyor which in this case is a screw auger which functions to firstly move the particulate material to its desired destination, and secondly to isolate the positive and/or negative pressure within the cyclone, hopper, or bin which ever the case may be from the exit end of the auger itself. The isolation of the pressure between the cyclone and the auger exit is critical in order to ensure efficiency in the movement of the particulate matter while entrained in air or other gases. Leakage of air or gases through the auger unit itself reduces the transport efficiency and/or the cyclone efficiency of the particulate matter while entrained in the air or gas.

### THE PRIOR ART

Auger conveying devices used in association with material plugs have been described and patented in U.S. Pat. No. 4,225,392 issued to Lelan D. Taylor in a Patent Titled: Pyrolysis Apparatus Issued: Sep. 30, 1980. In this device a feed auger terminates short of a reaction chamber to produce a sealing region (ie. a material plug) to effectively produce a gas tight seal preventing the exit of gaseous reaction products from the reaction chamber.

The use of material plugs to provide for gas tight sealing together with auger units is also described in U.S. Pat. No. 4,344,723 issued to Ellingson in a Patent Titled: Vacuum Grain Moving Apparatus Issued: Aug. 17, 1982. Material plug sealing systems are also discussed in U.S. Pat. No. 5,871,619 issued to Dana Finley et al. issued on Feb. 16, 1999.

In addition to the material plug, spring biased exit doors have also been found to be efficient in creating gas tight seals together with the material plug. This technology has been utilized, in particular, in deliquifying liquid slurries through augers and strainer baskets. The deliquification of liquid slurries through augers is discussed and described in U.S. Pat. No. 5,833,851 to Joseph Adams issued on Nov. 10, 1998, and is further discussed in U.S. Pat. No. 4,291,619 Titled: Screw Press With Controllable Rear Door issued to Arthur J. Hunt on Sep. 21, 1981, and is further discussed in U.S. Pat. No. 4,520,724 Titled: Screw Drive Particularly For Plastic Materials issued to Eduardo Costarelli on Jun. 4, 1985.

In addition to the prior art mentioned above, current methods of pressure isolating particulate conveying systems include rotary valves, feeder valves, star valves, double gate dump valves, and pinch valves, all of which attempt to pressure-isolate the inlet pressure or vacuum from the exit pressure or vacuum of a screw auger conveying device.

The prior art contemplates the use of a material plug together with a spring biased exit door for the movement of wet slurries in such a way to be able to isolate either negative or positive gas pressures from the entry and exit sides of the auger. This technology, however, has not successfully pressure isolated auger transport units to commercially acceptable levels.

### SUMMARY OF THE INVENTION

The present invention an auger lock for conveying particulate material there through comprises:

(a) a cylindrical housing receiving particulate material therein including an auger section, a material plug section, and an exit section;

(b) in said auger section; a rotatable spiral auger mounted concentrically on a rotatable drive shaft within said housing for conveying particulate material there through;

(c) in said material plug section; conveyed particulate material is allowed to accumulate and compact to form a material plug to substantially prevent flow of gases through said housing;

(d) in said exit section; a means for discharging said particulate material.

Preferably said discharge means includes a biased plunger moveable between a plunger open position and a plunger normally closed position, wherein said closed position said plunger seals off an exit end of said cylindrical housing preventing flow of material and gas through said exit end, and in said open position allowing flow of material through said exit end. Preferably said discharge means includes a means for diverting material radially outward toward the outer diameter of said cylindrical housing as said material approaches said exit end, thereby, ensuring that gases are substantially prevented from flowing past said material plug.

Preferably said diverting means includes a cylindrical deflector cone mounted concentrically on said drive shaft proximate said plunger, said deflector cone having an inclined deflector surface for diverting material radially outward proximate said exit end of said cylindrical housing.

Preferably said deflector cone diverts material radially outward prior to material flowing past said exit of said cylindrical housing when said plunger is in said open position.

Preferably said deflector cone diverts material radially outward prior to material flowing past said exit of said cylindrical housing when said plunger is in closed position.

Preferably said deflector cone diverts material radially outward only after material has flowed past said exit end when said plunger is in said open position.

Preferably said inclined deflector surface is angled between 20 and 60 degrees relative to a longitudinal axis taken through said drive shaft.

Preferably said inclined deflector surface is angled preferably between 30 and 45 degrees, relative to a longitudinal axis taken through said drive shaft.

Preferably said deflector cone is rigidly attached to said plunger, and in said closed position said plunger and cone remain stationary and in said open position said plunger and cone rotate together in unison with said drive shaft.

Preferably said plunger further includes means for grinding said material plug and breaking up said material plug into particles when said plunger is in said open position.

Preferably said grinding means includes agitator pins rigidly connected to said plunger and projecting into said material plug such that when said plunger rotates said agitator pins rotate and grind said material plug, thereby, breaking it down into smaller particles.

Preferably further comprising a means for selecting and adjusting the length of said cylindrical housing.

Preferably wherein said adjusting means includes a first auger tube section and a cooperating telescopically extending second auger tube section which can be slidably urged over first auger tube section for selectively adjusting the volume and length of said material plug section.

Preferably said discharge means includes a biased plunger moveable between a plunger open position and a plunger normally closed position, wherein said closed position said plunger seals off an exit end of said

cylindrical housing preventing flow of material and gas through said exit end, and in

said open position allowing flow of material through said exit end. Preferably said discharge means includes a means for diverting material radially outward toward the outer diameter of said cylindrical housing as said material approaches said exit end, thereby, ensuring that gases are substantially prevented from flowing past said material plug.

Preferably said diverting means includes a cylindrical deflector cone mounted concentrically on said drive shaft proximate said plunger, said deflector cone having an inclined deflector surface for diverting material radially outward proximate said exit end of said cylindrical housing.

In a presently preferred embodiment the present invention an auger lock for conveying particulate material there through, said auger lock comprises:

(a) an auger tube receiving particulate material therein including an auger section, a material plug section, and an exit section;

(b) in said auger section; a means for rotating a rotatable spiral auger mounted concentrically on a rotatable drive shaft within said auger tube for conveying particulate material there through;

(c) in said material plug section; conveyed particulate material is allowed to accumulate and compact to form a material plug to minimize free flow of gases through said auger tube; and

(d) in said exit section; a means for discharging said particulate material from said auger tube.

Preferably including biasing means for biasing said exit door into a closed position, wherein said exit door moveable between a exit door open position and a exit door closed position, wherein said closed position said exit door seals off an exit end of said auger tube preventing flow of material and gas through said exit end, and in said open position allowing flow of material through said exit end.

Preferably wherein in the closed position said exit door is stationary and in said open position said exit door rotates in unison with said auger.

Preferably wherein said drive shaft includes a hollow tubular auger shaft for receiving an exit shaft slideably and concentrically within said hollow auger shaft, wherein said door is rigidly attached to said exit shaft, and further including a seal to prevent material from entering into said hollow auger shaft.

Preferably further including a means for engaging said hollow auger shaft with said exit shaft at a predetermined exit door position.

Preferably wherein said engaging means includes a pin mounted transversely through said exit shaft and a cooperating slot in said hollow auger shaft for slidably receiving said pin therein at a predetermined exit door position thereby releasably locking together said hollow auger shaft and said exit shaft such that said exit door begins to rotate in unison with said auger shaft, when said exit door has achieved said predetermined position.

Preferably wherein said biasing means includes a tension spring connected at one end to said hollow auger shaft and at the other end connected to said exit shaft for urging said exit shaft slideably into said auger shaft thereby bringing said exit door into said closed position.

Preferably wherein said exit door further includes means for grinding said material plug and breaking up said material plug into particles when said exit door is rotating in said open position.

Preferably wherein said baising means is nested and concentrically disposed within said hollow auger shaft and connected at one end to said exit shaft and at the other end to a shaft end of said auger shaft.

Preferably wherein said baising means includes a tension spring and also a pretensioning means for preselectively adjusting the tension on the spring, said pretensioning means including a threaded adjusting rod cooperating with a threaded nut proximate a shaft end of auger shaft.

Preferably further comprising a means for preselectively adjusting the length of said auger tube.

Preferably wherein said adjusting means includes a first auger tube section and a cooperating telescopically extending second auger tube section which can be cooperatively slidably urged over first auger tube section for selectively adjusting the volume and length of said auger tube and therefore said material plug section.

### BRIEF DESCRIPTION OF THE DRAWINGS

The present invention will now be described by example only with reference to the following drawings in which:

FIG. 1 is a schematic side cross-sectional view of the auger lock together with a cyclone showing the flow of material through the auger.

FIG. 2 is a schematic side cross-sectional view of the auger lock shown in FIG. 1 without showing the material moving through the auger for better viewing of the details with plunger in the closed position.

FIG. 3 is schematic cross-sectional side view of the auger lock shown in FIG. 1 without the material present for better view of the details with the plunger in the open position.

FIG. 4 is a schematic cross-sectional side view of an alternate embodiment of said auger lock.

FIG. 5 is a schematic cross-sectional side view of an alternate embodiment of said auger lock.

FIG. 6 is a schematic cross-sectional side view of an alternate embodiment of said auger lock.

FIG. 7 is a schematic cross-sectional side view of an alternate embodiment of said auger lock.

FIG. 8 is a schematic cross-sectional side view of the presently preferred embodiment of the auger lock in the door open position.

FIG. 9 is a schematic cross-sectional view of the presently preferred embodiment of the auger lock in the door closed position.

FIG. 10 is a schematic cross-sectional view of the presently preferred embodiment highlighting some aspects of the auger lock.

### DETAILED DESCRIPTION OF THE PREFERRED EMBODIMENT

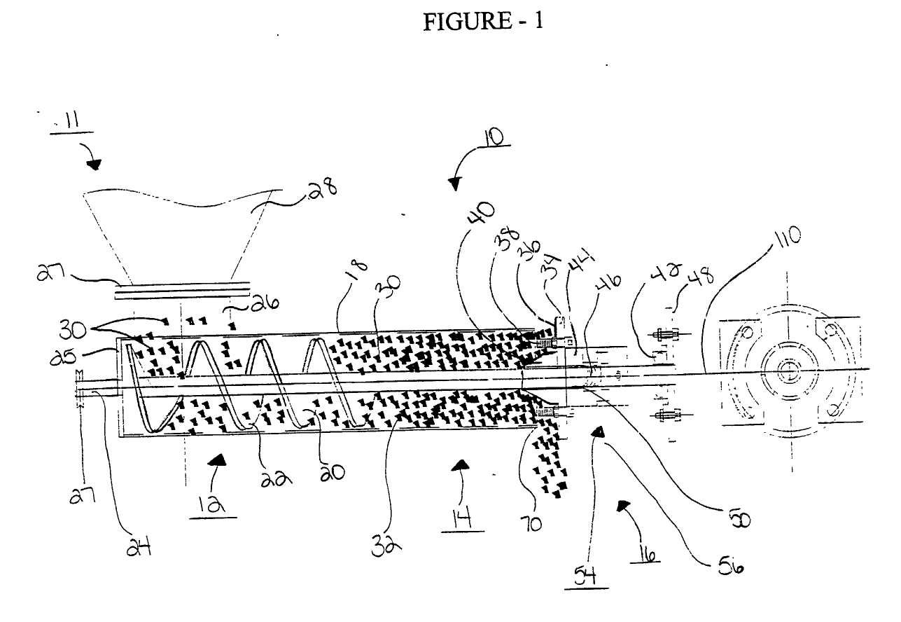

The present invention, an auger lock, shown generally as 10 in FIG. 1 includes the following major sections, intake section 11, auger section 12, material plug section 14, and exit section 16.

Referring now to FIG. 1 intake section 11 includes a cyclone 28 which also may be a hopper or a storage bin in which material 30 is entrained within a gas. Intake section 11 further includes intake flange 27 which communicates with intake 26 which communicates with auger tube 18.

Auger section 12 includes a cylindrical housing; namely, auger tube 18 having mounted therein auger 20 having auger flights 22. Auger 20 which is mounted on drive shaft 24 which is mounted centrally and longitudinal along longitudinal axis 110 within auger tube 18 as shown in FIG. 1. By way of example only, auger tube 18 may have an outside diameter of five inches, wall thickness of 3/16 of an inch and houses an auger 20 having auger flights 22 having an outside diameter of four inches. Auger flights 22 are preferably half pitch flights, meaning a four inch auger would have two inch pitch auger flights 22. Auger tube 18 has mounted thereon end cap 25 proximate intake section 11. One end of drive shaft 24 emerges from end cap 25 and has mounted thereon drive pulley 27. Preferably drive pulley 27 is of the sprocket type, however, other drive arrangements known in the art can also be used including belt driven arrangements. Not shown in FIG. 1 is a motor and drive system connected to drive pulley 27 for rotating drive shaft 24.

Auger flights 22 terminate at material plug section 14 wherein only drive shaft 24 and material 30 continue within auger tube 18. In other words the auger flights 22 terminate and do not enter material plug section 14. Material 30 within material plug section 14 compacts together forming compacted material 32 within material plug section 14.

Exit section 16, which includes a means for discharging material 30, includes plunger 34, rubber seal 36, agitator pins 38, deflector cone 40, two way dogs 44, spring 46, shaft bearing 42, and mounting bracket 48. FIG. 1 shows plunger 34 in plunger open position 56 wherein two way dogs 44 are in engaged position 54 as shown in FIG. 1.

In addition, seals 50 located between the inner diameter of deflector cone 40 and the outer diameter of drive shaft 24, provide for a gas-tight seal between deflector cone 40 and drive shaft 24. Preferably seals 50 are of the o-ring type, however, brass bushing type seals and/or any other seals known in the art which allow deflector cone 40 to move slidably, longitudinally along drive shaft 24 are acceptable.

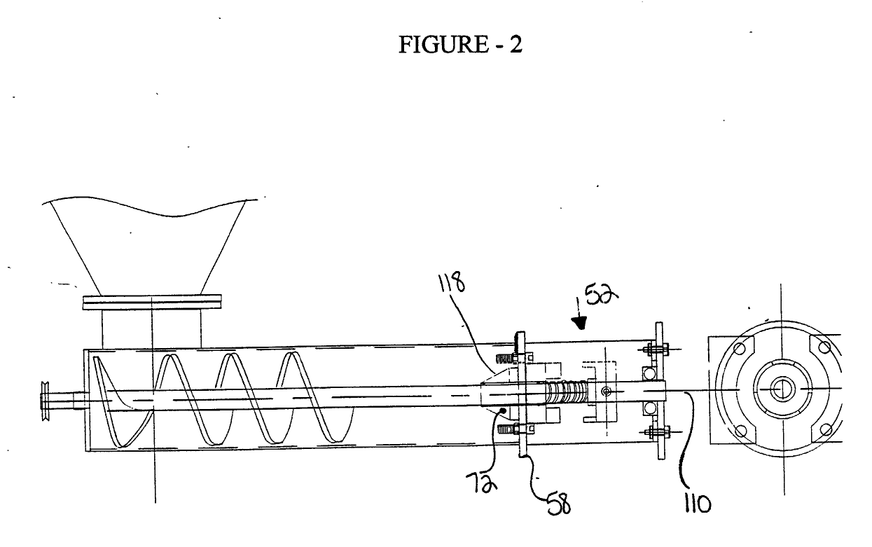

Plunger 34 has mounted thereon rubber seal 36 on the face which contacts the exit end 70 of auger tube 18, in plunger closed position 58 shown in FIG. 2.

Exit section 16 which includes plunger 34, rubber seal 36, agitator pins 38, deflector cone 40, and two way dogs 44 move in unison slidably along drive shaft 24 between a plunger open position 56 shown in FIG. 1, and a plunger closed position 58 shown in FIG. 2.

In plunger closed position 58 shown in FIG. 2, two way dogs 44 are in dog disengaged position 52 shown in FIG. 2.

Two way dogs 44 are the type known in the art and preferably are three-toothed dogs which cooperate wherein the engaged position 54, the two way dogs 44 are meshed together thereby rotating plunger 34, rubber seal 36, agitator pins 38, and deflector cone 40 in unison with drive shaft 24.

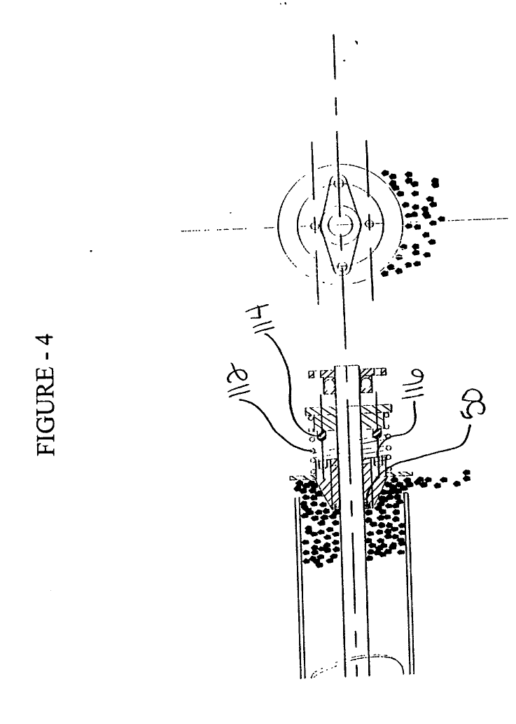

FIG. 4, an alternate embodiment of auger lock 10, schematically illustrates using engaging pins 114 and co-operating engaging pin holes 116 rather than two way dogs 44. In addition, spring 112 is located exterior of the engaging mechanism.

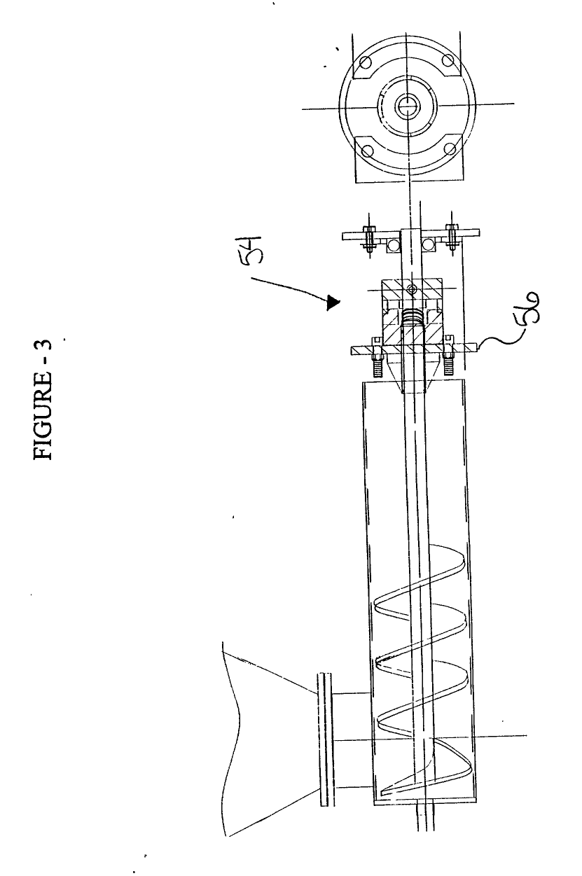

Referring to FIGS. 1 through 3 in dogs disengaged position 52 the dog teeth no longer mesh and plunger 34, rubber seal 36, agitator pins 38, and deflector cone 40 no longer rotate in unison with drive shaft 24, but rather drive shaft 24 rotates freely with plunger 34 left stationary with rubber seal 36 of plunger 34 sealing and mating against exit end 70 of auger tube 18.

Spring 46 biases plunger 34 against exit end 70 of auger tube 18, and maintains plunger 34 in the normally plunger closed position 58 shown in FIG. 2.

Shaft bearing 42 supports the exit end of drive shaft 24 onto mounting bracket 48 of the type known in the art. Not shown is a frame or other structure to which bracket 48 is mounted.

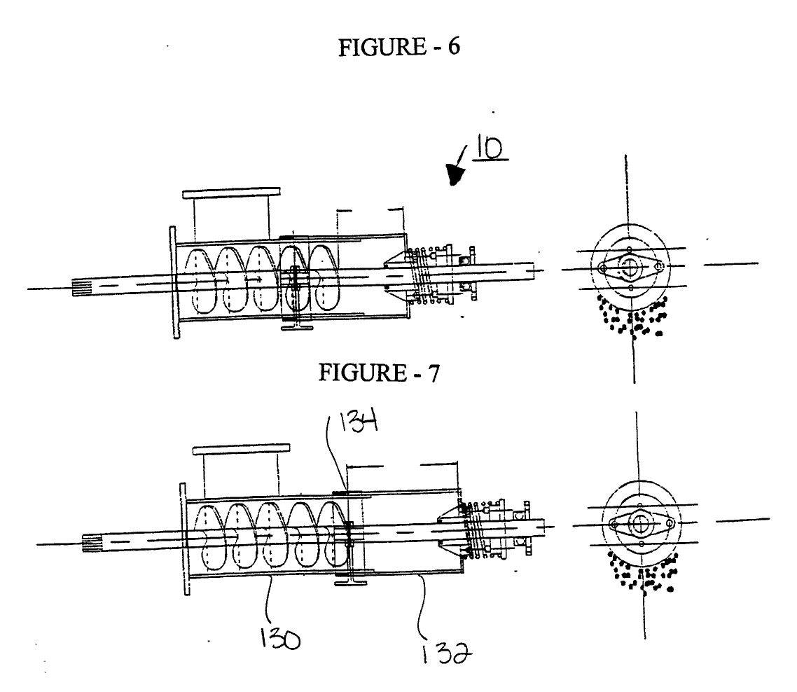

Referring now to FIGS. 6 and 7 which schematically illustrates an alternate embodiment of the present invention, an auger lock 10, which has all of the same components as described above except for modification to auger tube 18 which is comprised of two sections; namely, first auger tube section 130 and second auger tube section 132, which is coupled together with coupling 134. First and second auger tube sections 130 and 132 are dimensioned to co-operatively, telescopically slide one over the other in such a manner that the length of the auger tube can be adjusted by slidably urging second auger tube section 132 over first auger tube section 130, and locking it into a desired position using coupling 134. In this manner the volume and the length of material plug section 14 containing compacted material 32 can be adjusted by slidably urging second auger tube section 132 telescopically over, first auger tube section 130. Coupling 134 can be any type known in the art and, for example, a LORENZE™ standard coupling, which is described in U.S. Pat. No. 4,193, 173 and Canadian Patent 1,025,793 can suitably be used.

In use auger lock 10 as shown in FIG. 1, operates as will be described hereafter.

Material 30, which is contained within cyclone 28, settles to the bottom of cyclone 28 proximate intake flange 27. Material 30 flows through intake 26 and into auger tube 18 proximate intake section 11. Auger lock 10 will work with almost any type of dry or wet particulate or granular material and/or bulk solids such as plastic particles (something called rubber regrind), plastic pellets, grain, saw dust, cement dust, rubber powder, and other similar granular materials. Preferably, the material 30 size ranges between 100 mesh and ¾″ in diameter in size. Material 30 can be almost any type of material which is capable of being moved along through auger 20 mounted within auger tube 18. The interior of cyclone 28 may be under negative and/or positive pressure, and in practice the unit has been tested to be functional between 80 inches of water column pressure and/or 80 inches of water column vacuum using plastic regrind material through the auger. Higher pressures and vacuums are likely achievable. Therefore, auger lock 10 can be utilized with either a negative pressure within cyclone 28 and/or a positive pressure within cyclone 28.

As material 30 is transported into auger tube 18, rotating auger flights 22 of auger 20 move material 30 longitudinally from intake section 11 of auger tube 18 towards exit end 70 of auger tube 18. Typically drive shaft 24 rotates between 25 to 50 rpm As material 30 is moved into material plug section 14, the auger flights 22 terminate and material 30 begins to accumulate and compact within material plug section 14.

Spring 46 biases plunger 34 against exit end 70 of auger tube 18 preventing any material 30 and gas from exiting from exit end 70 of auger tube 18.

Preferably, a rubber seal 36 mounted onto plunger 34 mates with and seals off exit end 70 of auger tube 18, thereby, preventing material 30 and gas or air from flowing past plunger 34 during the start up of auger lock 10.

As auger flights 22 continue to rotate and move more and more material 30 into material plug section 14, material 30 eventually becomes highly compacted forming compacted material 32 within material plug section 14. Compacted material 32 is also know as a “material plug” in the art. Compacted material 32 is so highly compacted that it substantially prevents the flow of gases between cyclone 28 and exit end 70 of auger tube 18. Thereby pressure isolating any positive or negative pressures in cyclone 28 from the ambient pressure found at exit end 70 of auger tube 18.

As auger flights 22 continue to rotate, the pressure continually increases increasing the compaction of material 30 within material plug section 14 until the pressure is great enough to overcome the biasing action of spring 46 against plunger 34. When the pressure of material plug 14 is sufficient to overcome the biasing force of spring 46, compacted material 32 within material plug section 14 pushes against plunger 34 moving plunger 34 from the plunger closed position 58 to the plunger open position 56, thereby engaging two way dogs 44 into the engaged position wherein plunger 34 begins rotating in unison with drive shaft 24.

During this entire process drive shaft 24 is being rotated by a motor or other means known in the art, via drive pulley 27. It will be apparent to those skilled in the art that the power required to continually rotate drive shaft 24 will depend among others upon the size of auger tube 18, and the type of material 30 transported within the auger lock 10.

With plunger 34 in the plunger open position 56, rubber seal 36 no longer contacts exit end 70 of auger tube 18, therefore breaking the seal between plunger 34 and exit end 70 of auger tube 18. However, because compacted material 32 is so densely compacted it continues to substantially isolate the pressure and/or vacuum found in cyclone 28 from the ambient air pressure found at exit end 70 of auger tube 18.

As two way dogs 44 move into the engaged position 54, plunger 34 begins to rotate which in turn rotates agitator pins 38, which are rigidly connected to plunger 34. Agitator pins 38 are mounted longitudinally and parallel with auger tube 18, and as depicted can be bolts and/or any rigid projections into the interior of auger tube 18.

The length of agitator pins 38 is selected depending upon material 30 consisting and size. By way of example only, finer material 30 requires longer pins, whereas, coarser material 30 requires shorter pins.

As compact material 32 begins to move outwardly from exit end 70 it makes contact with rotating agitator pins 38 which breaks up compacted material 32, allowing material 30 (which is broken up) to exit from exit end 70 of auger tube 18.

Finally, deflector cone 40, a cone-shaped deflector mounted on drive shaft 24, directs material 30 radically outward away from drive shaft 24, and towards the outer diameter of auger tube 18 and towards agitator pins 38. In practice it has been found critical to have deflector cone 40 in place in order to provide additional compaction of material 30 as it approaches exit end 70 of auger tube 18.

Deflector cone 40 has inclined deflecting surface 118 for deflecting material 30 radially outward.

By deflecting and moving material radically outward away from the centre of drive shaft 24 and towards the outer diameter of auger tube 18, additional compaction of material 30 occurs. This additional compaction as material 30 exits from exit end 70 of auger tube 18 is critical to ensure that a gas seal is maintained in material plug section 14 even though plunger 34 no longer seals with rubber seal 36 against exit end 70 of auger tube 18. The angle theta 72 is the angle between the longitudinal axis 110 which runs parallel along the longitudinal length of drive shaft 24, and the inclined deflecting surface 118 of deflector cone 40. Preferably the angle theta 72 is 30 degrees. In practice, angle theta 72 can range between 20 to 60 degrees, however, 30 to 45 degrees is more preferable.

Referring now to the alternate embodiment shown in FIGS. 6 and 7, the volume and length of material plug section 14 can be adjusted by telescopically urging second auger tube section 132 over first auger tube section 130, and locking the two auger sections in place with coupling 134. This is particularly useful when different sized material 30 is fed through auger 20. By way of example only, finer material 30 being fed through auger 20 requires a smaller material plug section 14, and therefore, a smaller and shorter material plug. Finer materials tend to compact more easily, and therefore, a more effective material plug can be achieved with finer materials. By reducing material plug section 14 the amount of horsepower required by auger lock 10 is reduced, and the efficiency of auger lock 10 is increased.

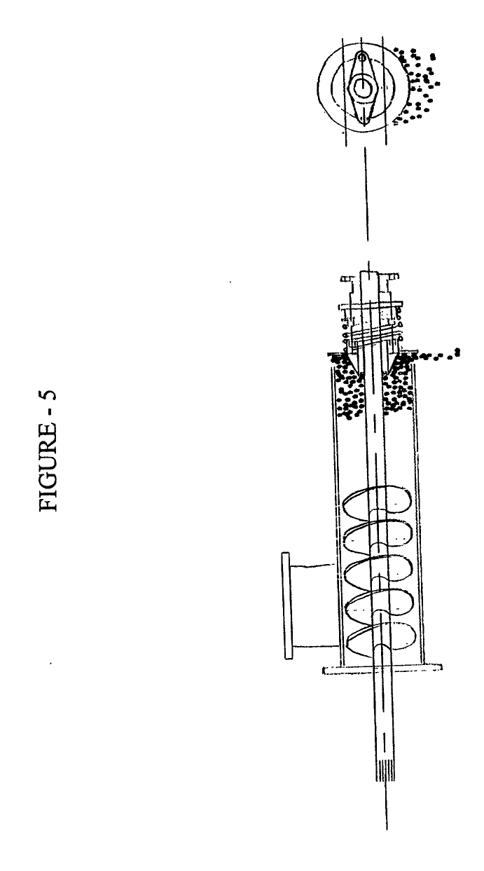

Conversely, as the material 30 becomes coarser in nature, a longer material plug section is required in order to provide for an efficient gas tight seal. Therefore, the courser the material the longer the material plug section 14 would be, and therefore, second auger tube section 132 is urged outwardly extending the length of the auger tube in order to provide for a longer and larger material plug. In this way the operator can fine tune the operation of auger lock 10 by adjusting the length of material plug section 14 according to the size and the consistency of material 30 being fed through auger 20. In all other aspects, auger lock 10, as shown in FIGS. 6 and 7, operates in an elegance fashion as auger lock 10 shown in FIGS. 1 through 5 as described here above.

Presently Preferred Embodiment

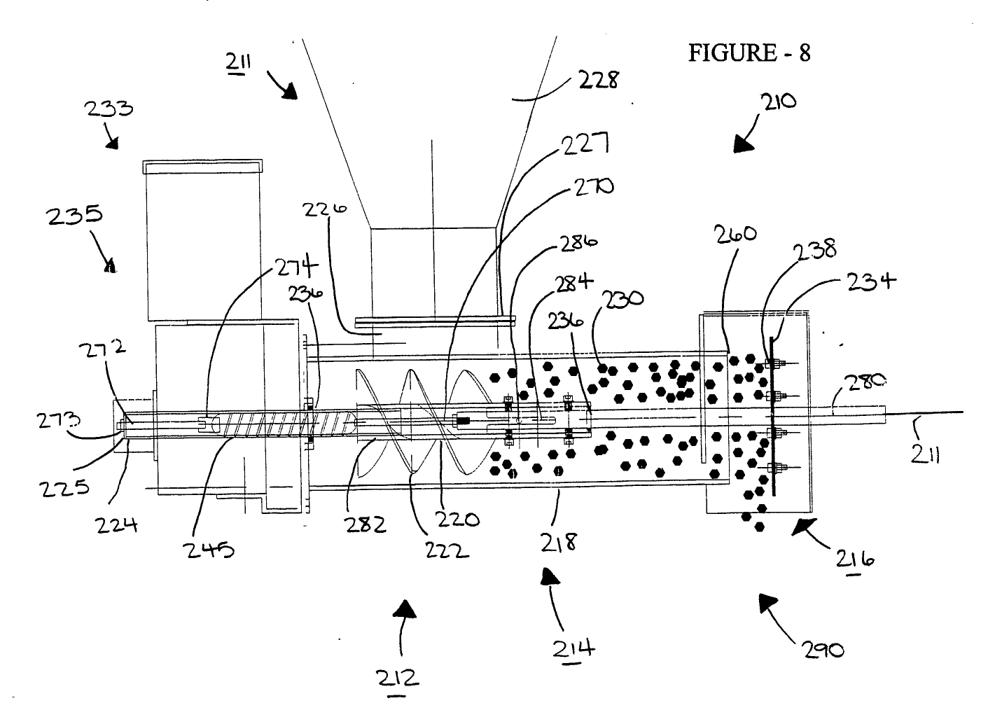

In a presently preferred embodiment of the invention, an auger lock shown generally as 210 in FIG. 8, includes the following major sections. Intake section 211, drive section 233, auger section 212, material plug section 214 and exit section 216.

Referring now to FIG. 1, the intake section 211 includes a cyclone 228 which also may be a hopper or storage bin in which material 230 is entrained with a gas. Intake section 211 further includes intake flange 227 which provides for communication between cyclone 228 and auger tube 218.

Drive Section 233 includes drive unit 235 mounted to auger tube 218. Drive unit 235 is driveably connected to drive end shaft 224 and auger shaft 282 which is connected to auger 220 for rotatably driving drive end shaft 224 and auger shaft 282. Drive unit 235 is a standard type of drive mechanism which can be purchased and is mechanically and/or hydraulically and/or pneumatically connected to drive end shaft 224 through gears, pulleys or belts or other means not shown in FIG. 8. The purpose of drive unit 235 is to rotate a drive end shaft 224 which is connected to auger shaft 282 which in turn rotates auger 220 with its auger flights 222.

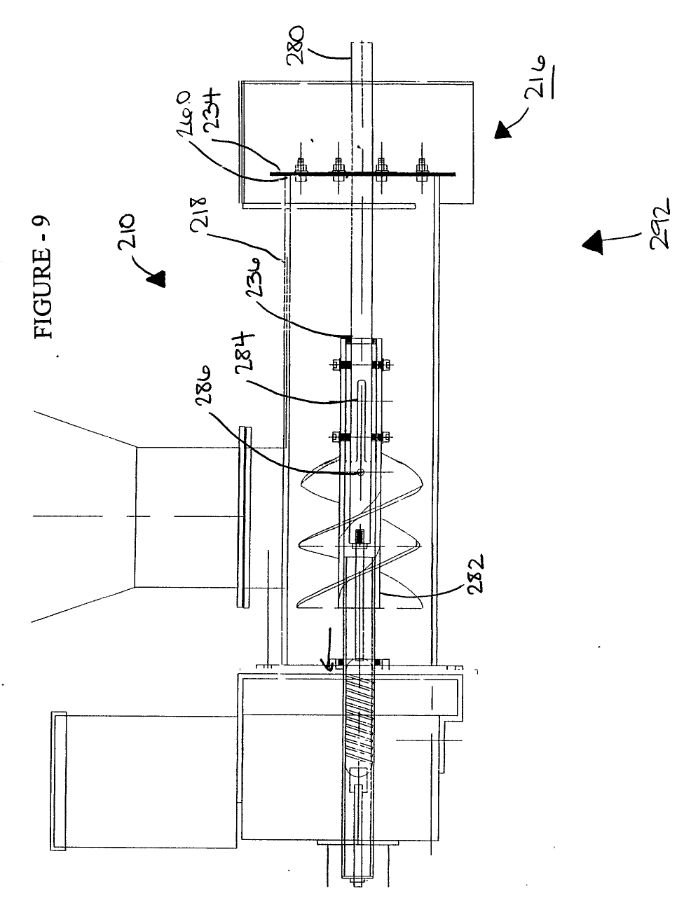

The reader will note that drive end shaft 224 is hollow and houses therein an adjusting rod 272 connected at the shaft end 225 together with an adjusting nut 273. Adjusting rod 272 having at the other end a swivel 274 for connecting to one end of spring 245. The other end of spring 245 is connected to connecting rod 270 which in turn is attached to exit shaft 280. The tension on spring 245 can be adjusted by threadably turning adjusting nut 273 of adjusting rod 272 which is threaded. By turning adjusting nut 273, adjusting rod 272 is urged along longitudinal axis 211 thereby selectively increasing or decreasing the tension on spring 245. Note that drive end shaft 224 is rigidly connected with auger shaft 282, however, exit shaft 280 which is concentrically housed within auger shaft 282 moves freely and independently of auger shaft 282 and drive end shaft 224, in the door closed position 292 shown in FIG. 9.

Exit shaft 280 also has mounted there through laterally a pin 286 which has portions on each side of the pin projecting beyond the diameter of exit shaft 280. Pin 286 is dimensioned to fit within slot 284 defined in auger shaft 282 for the purpose of driveably connecting auger shaft and drive end shaft with exit shaft 280.

Auger lock 210 shown in FIG. 8 is shown in the door open position 290 in which pin 286 has made engagement with slot 284 thereby drive end shaft 224, auger shaft 282 and exit shaft 280 all rotate in unison due to the coupling of pin 286 with slot 284.

Furthermore, seal 236 at the end of auger shaft 282 and near the drive unit 235 seals off material 230 from contaminating the mechanism found within drive end shaft 224.

FIG. 9 shows auger lock 210 in the door closed position 292 in which the tension on spring 245 which is transmitted through exit shaft 280 forces exit door 234 closed against exit end 260 of auger tube 218. In this position lateral pin 286 does not engage with slot 284 and therefore drive end shaft 224 and auger shaft 282 rotate in unison, however exit shaft 280 rigidly connected to exit door 234 does not rotate unless pin 286 engages with slot 284.

Therefore, in the door closed position 292 exit door 234 does not rotate and agitator pins 238 do not impart any forces upon material 230 within auger tube 218.

In use, auger lock 210 operates as follows. Material 230 drops out of cyclone 228 through intake flange 227 of intake 226 and into auger tube 218 whereby they encounter the rotating auger flights 222 of auger 220. The spring tension on spring 245 is adjusted by adjusting nut 273 to impart enough force on exit shaft 280 which transfers this force to exit door 234 thereby keeping it closed and in the door closed position 292 against exit end 260. Therefore, initially only drive end shaft 224 and auger shaft 282 rotate leaving exit shaft 280 attached to exit door 234 stationary.

Auger flights 222 continually transport material 230 towards exit end 260 of auger tube 218 until a material plug of material is formed in material plug section 214 of auger tube 218. A material plug is a conglomeration of material 230 within auger tube 218. Material 230 is compacted together in this material plug. Once the material plug has obtained sufficient size, it begins imparting forces against exit door 234 thereby pushing open exit door 234 against the tension on spring 245. Once exit door 234 has opened a predetermined amount, pin 286 engages with slots 284 thereby beginning rotation of exit shaft 280 with exit door 234 attached. Once exit door 234 begins to rotate, agitator pins 238 begin to grind away material 230 from material plug thereby dropping the material into a bin or a hopper below not shown.

The size of the material plug and the amount that the exit door opens is depended upon the pretension placed on spring 245 and the tension characteristics of spring 245 as well as the amount the exit door must open prior to the engagement of pin 286 with slot 284. Thereby the characteristics and the size of the material plugs can be adjusted by adjusting the tension on spring 245 as well by selecting the distance between pin 286 and slot 284 in the door closed position 292.

The greater the distance between pin 286 and slot 284 in the door closed position 292 the longer the material plug will form prior to exit door 234 rotating and agitator pin 238 grinding away the material plug.

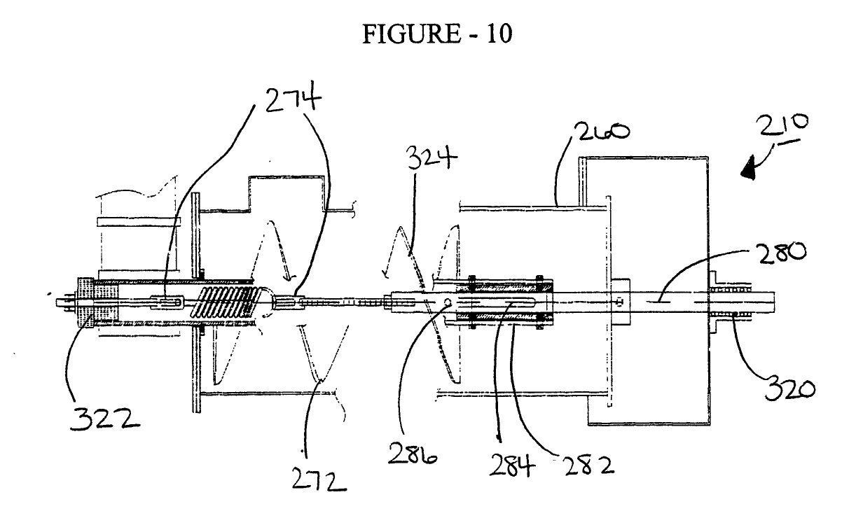

Referring now to FIG. 10, which is schematic representation of auger lock 210 showing FIGS. 8 and 9, highlighting some aspects of auger lock 210 not shown in FIGS. 8 and 9. Preferably a linear bearing 320 would be mounted onto the end of exit shaft 280 as shown in FIG. 10 in order to provide for support for exit shaft 280. In addition, a bushing 322 is preferrably used at the shaft end 225 of drive end shaft 224 as shown in FIG. 10.

Preferably also double pitch flighting 324 on auger 220 would be mounted onto auger shaft 282 approximate the exit end of auger flights 222.

In addition to the arrangement shown in FIGS. 8, 9 and 10 for auger lock 210, additionally the auger tube 218 arrangement shown in FIGS. 6 and 7 for the previous embodiment apply equally well to the presently preferred embodiment namely auger lock 210. Clarity auger tube 218 could be constructed of two auger tubes sections similar to first auger tube section 130 and second auger tube section 132 shown in FIGS. 6 and 7. A coupling 134 shown in FIG. 7 and FIG. 6 would also be used and this arrangement would enable one to adjust the total length of auger tube 218, thereby providing very gross and course control of the material plug section 214.

For example by extending second auger tubes section 132 over first auger tube section 130 thereby lengthening the total length of auger tube 218, one can in effect increase the length of new material plug section 214 thereby increase the length of the material plug which is formed. This is useful for example when very course materials are being fed through auger lock 210 in order to provide for a better gas type seal the material plug section 214 would be made greater.

On the other hand should finer materials or materials be used which provide for better gas tightness in the material plug section, then first auger tube section 130 and second auger tube section 132 could be urged over each other thereby shortening material plug section 214 and in this matter increasing the efficiency of the operation of auger lock 210.

It should be apparent to persons skilled in the arts that various modifications and adaptation of this structure described above are possible without departure from the spirit of the invention the scope of which defined in the appended claim.

I claim:

1. An auger lock for conveying particulate material there through, said auger lock comprising:
(a) a cylindrical housing receiving particulate material therein including an auger section, a material plug section, and an exit section;
(b) in said auger section; a rotatable spiral auger mounted concentrically on a rotatable drive shaft within said housing for conveying particulate material there through;
(c) in said material plug section; conveyed particulate material is allowed to accumulate and compact to form a material plug to substantially prevent flow of gases through said housing;
(d) in said exit section; a means for discharging said particulate material.

2. The auger lock claimed in claim 1 wherein said discharge means includes a biased plunger moveable between a plunger open position and a plunger normally closed position, wherein said closed position said plunger seals off an exit end of said cylindrical housing preventing flow of material and gas through said exit end, and in said open position allowing flow of material through said exit end.

3. The auger lock claimed in claim 2 wherein said discharge means includes a means for diverting material radially outward toward the outer diameter of said cylindrical housing as said material approaches said exit end, thereby, ensuring that gases are substantially prevented from flowing past said material plug.

4. The auger lock claimed in claim 3 wherein said diverting means includes a cylindrical deflector cone mounted concentrically on said drive shaft proximate said plunger, said deflector cone having an inclined deflector surface for diverting material radially outward proximate said exit end of said cylindrical housing.

5. The auger lock claimed in claim 4 wherein said deflector cone is rigidly attached to said plunger, and in said closed position said plunger and cone remain stationary and in said open position said plunger and cone rotate together in unison with said drive shaft.

6. The auger lock claimed in claim 3 wherein said plunger further includes means for grinding said material plug and breaking up said material plug into particles when said plunger is in said open position, wherein said grinding means includes agitator pins rigidly connected to said plunger and projecting into said material plug such that when said plunger rotates said agitator pins rotate and grind said material plug, thereby, breaking it down into smaller particles.

7. The auger lock claimed in claim 1 further comprising a means for selecting and adjusting the length of said cylindrical housing.

8. The auger lock claimed in claim 9 wherein said adjusting means includes a first auger tube section and a co-operating telescopically extending second auger tube section which can be slidably urged over first auger tube section for selectively adjusting the volume and length of said material plug section.

9. An auger lock for conveying particulate material there through, said auger lock comprising:
(a) an auger tube receiving particulate material therein including an auger section, a material plug section, and an exit section;
(b) in said auger section; a means for rotating a rotatable spiral auger mounted concentrically on a rotatable drive shaft within said auger tube for conveying particulate material there through;
(c) in said material plug section; conveyed particulate material is allowed to accumulate and compact to form a material plug to minimize free flow of gases through said auger tube; and
(d) in said exit section; a means for discharging said particulate material from said auger tube.

10. The auger lock claimed in claim 9 including biasing means for biasing said exit door into a closed position, wherein said exit door moveable between a exit door open position and a exit door closed position, wherein said closed position said exit door seals off an exit end of said auger tube preventing flow of material and gas through said exit end, and in said open position allowing flow of material through said exit end.

11. The auger lock claimed in claim 10 wherein in the closed position said exit door is stationary and in said open position said exit door rotates in unison with said auger.

12. The auger lock claimed in claim 11 wherein said drive shaft includes a hollow tubular auger shaft for receiving an exit shaft slideably and concentrically within said hollow auger shaft, wherein said door is rigidly attached to said exit shaft, and further including a seal to prevent material from entering into said hollow auger shaft.

13. The auger lock claimed in claim 12 further including a means for engaging said hollow auger shaft with said exit shaft at a predetermined exit door position.

14. The auger lock claimed in claim 13 wherein said engaging means includes a pin mounted transversely through said exit shaft and a cooperating slot in said hollow auger shaft for slidably receiving said pin therein at a predetermined exit door position thereby releasably locking together said hollow auger shaft and said exit shaft such that said exit door begins to rotate in unison with said auger shaft, when said exit door has achieved said predetermined position.

15. The auger lock claimed in claim 13 wherein said biasing means includes a tension spring connected at one end to said hollow auger shaft and at the other end connected to said exit shaft for urging said exit shaft slideably into said auger shaft thereby bringing said exit door into said closed position.

16. The auger lock claimed in claim 11 wherein said exit door further includes means for grinding said material plug and breaking up said material plug into particles when said exit door is rotating in said open position.

17. The auger lock claimed in claim 12 wherein said baising means is nested and concentrically disposed within said hollow auger shaft and connected at one end to said exit shaft and at the other end to a shaft end of said auger shaft.

18. The auger lock claimed in claim 17 wherein said baising means includes a tension spring and also a pretensioning means for preselectively adjusting the tension on the spring, said pretensioning means including a threaded adjusting rod cooperating with a threaded nut proximate a shaft end of auger shaft.

19. The auger lock claimed in claim 9 further comprising a means for preselectively adjusting the length of said auger tube.

20. The auger lock claimed in claim 19 wherein said adjusting means includes a first auger tube section and a co-operating telescopically extending second auger tube section which can be cooperatively slidably urged over first auger tube section for selectively adjusting the volume and length of said auger tube and therefore said material plug section.
